(19) United States
(12) Patent Application Publication
(10) Pub. No.: US 2024/0347819 A1
(43) Pub. Date: Oct. 17, 2024

(54) CASING FOR HOLDING AN IONIC LIQUID COMPRISING ALUMINUM CHLORIDE, AND BATTERY CELL HAVING SUCH A CASING

(71) Applicant: Fraunhofer-Gesellschaft zur Förderung der angewandten Forschung e.V., München (DE)

(72) Inventors: Ulrike WUNDERWALD, Erlangen (DE); Maximilian WASSNER, Erlangen (DE)

(73) Assignee: Fraunhofer-Gesellschaft zur Förderung der angewandten Forschung e.V., München (DE)

(21) Appl. No.: 18/676,528

(22) Filed: May 29, 2024

Related U.S. Application Data
(63) Continuation of application No. PCT/EP2022/083251, filed on Nov. 25, 2022.

(30) Foreign Application Priority Data
Nov. 29, 2021 (DE) 102021213444.0

(51) Int. Cl. H01M 50/121; H01M 10/54; H01M 50/103; H01M 50/105; H01M 50/107; H01M 50/124; H01M 50/129; H01M 50/133

(52) U.S. Cl. CPC H01M 50/121; H01M 10/54; H01M 50/103; H01M 50/105; H01M 50/107; H01M 50/1243; H01M 50/1245; H01M 50/129; H01M 50/133; H01M 2300/002

(57) ABSTRACT

Embodiments provide a casing for holding an ionic liquid comprising aluminum chloride, the casing being a multi-layer casing, the casing having a diffusion-tight layer, the casing having a layer comprising polyether ether ketone, PEEK, wherein, when the casing is filled with the ionic liquid having aluminum chloride, the layer having polyether ether ketone, PEEK, is arranged between the diffusion-tight layer and the ionic liquid having aluminum chloride.

### CROSS-REFERENCE TO RELATED APPLICATIONS

This application is a continuation of copending International Application No. PCT/EP2022/083251, filed Nov. 25, 2022, which is incorporated herein by reference in its entirety, and additionally claims priority from German Application No. 102021213444.0, filed Nov. 29, 2021, which is also incorporated herein by reference in its entirety.

### TECHNICAL FIELD

Embodiments relate to a casing for holding an ionic liquid comprising aluminum chloride. Further embodiments relate to a battery cell having a casing for holding an ionic liquid comprising aluminum chloride. Further embodiments relate to a configuration of a corrosion-resistant aluminum ion battery cell.

### BACKGROUND OF THE INVENTION

In a conventional aluminum ion battery (AIB), the reversible charge transport is realized by means of a liquid electrolyte. Usually, this electrolyte consists of aluminum chloride (AlCl₃) and a further component. Such an electrolyte can be associated to ionic liquids (IL), or the associated sub-group of so-called deep eutectic solvents (DES) which exhibit a very high Lewis acidity. However, this characteristic is accompanied by a very strong corrosive effect on metals and plastics.

This problem is now to be described exemplarily for an aluminum dual ion graphite battery, ADGB. Cell chemistry of the ADGB is based on an aluminum anode, a graphite cathode and an ionic liquid, while adding AlCl₃, which, as an electrolyte, allows charge transport. Here, ethyl methyl imidazolium chloride:AlCl₃ (EMlm[Cl]:AlCl₃) is frequently used as the ionic liquid. However, numerous further electrolytes are known, which can be associated to the sub-group of deep eutectic solvents type IV, like urea:AlCl₃ of acetamide (AcAm):AlCl₃ or further combinations of amides with AlCl₃ [1], for example. These electrolytes (like IL and DES) are very strong Lewis acids which numerous metals and plastics are not resistant too. Selected long term-resistant metals which are required as current drains on the cathode side are molybdenum and tungsten [2]. Due to its very low brittleness, molybdenum film is frequently used as a corrosion-resistant current drain. The active material is deposited on the molybdenum film in the form of graphite particles while adding a binding agent, by means of aqueous slurry. Al film bags (so-called pouch bags) having an internal electrically insulating and corrosion-resistant coating made of fluorine-containing polymers, like polytetrafluoroethylene (PTFE) and fluoroethylene propylene (FEP) are known For the cell casing [3]. These fluorine-containing polymers, however, are problematic as regards their thermoplastic characteristics. They can only be welded to a limited extent, which, however, is a necessary process step for air-tight sealing of the cell. In addition, deep drawability of the pouch bag for using multi-layered electrodes is restricted. Polyamide (PA) or polyethylene terephthalate (PET) is used for an external electrically insulating coating of the pouch bag.

Thus, the object underlying the present invention is providing a concept for a casing for a battery cell, which is easier to manufacture and/or is more resistant towards the electrolyte mentioned above.

### SUMMARY

According to an embodiment, a battery cell may have: a two-layer film bag, two electrodes, and a separator arranged between the two electrodes, wherein the two electrodes and the separator are arranged in the two-layer film bag, wherein the two-layer film bag is filled with an electrolyte, wherein a protective layer of the two-layer film bag, which is in contact with the electrolyte, has polyether ether ketone, PEEK, wherein the protective layer is a polyether ether ketone, PEEK, film bag, wherein the two-layer film bag has an aluminum film bag coated with polyamide on an external side, wherein the polyether ether ketone, PEEK, film bag is introduced into the aluminum film bag.

According to another embodiment, a pouch cell may have: a two-layer film bag, two electrodes, and a separator arranged between the two electrodes, wherein the two electrodes and the separator are arranged in the two-layer film bag, wherein the two-layer film bag is filled with an electrolyte, wherein a film layer of the two-layer film bag, which is in contact with the electrolyte, has polyether ether ketone, PEEK, wherein the film layer which is in contact with the electrolyte is a polyether ether ketone, PEEK, film bag, wherein the two-layer film bag has an aluminum film bag coated with polyamide on an external side, wherein the polyether ether ketone, PEEK, film bag is introduced into the aluminum film bag.

According to another embodiment, a method of manufacturing a battery cell may have the steps of: providing a two-layer film bag, providing two electrodes in the multi-layer cell casing, providing a separator between the two electrodes, filling the cell casing with an electrolyte, wherein a protective layer of the multi-layer cell casing, which is in contact with the electrolyte, has polyether ether ketone, PEEK, wherein the step of providing the two-layer film bag has: providing a polyether ether ketone, PEEK, film bag as a protective layer, providing an aluminum film bag which is coated with polyamide on an external side, introducing the polyether ether ketone, PEEK, film bag into the aluminum film bag.

According to still another embodiment, a method of manufacturing a pouch cell may have the steps of: providing a two-layer film bag, providing two electrodes in the two-layer film bag, providing a separator between the two electrodes, filling the two-layer film bag with an electrolyte, wherein a protective layer of the two-layer film bag, which is in contact with the electrolyte, has polyether ether ketone, PEEK, wherein the step of providing the two-layer film bag has: providing a polyether ether ketone, PEEK, film bag as a protective layer, providing an aluminum film bag which is coated with polyamide on an external side, introducing the polyether ether ketone, PEEK, film bag into the aluminum film bag.

As mentioned above, the reversible charge transport in a battery, like an aluminum ion battery (AIB), is usually realized by an electrolyte comprising aluminum chloride (AlCl₃), which exhibits a very high Lewis acidity and, consequently, a strong corrosive effect on metals and plastics. Consequently, the idea underlying the present invention is, in a casing of a battery cell which exemplarily comprises a metal layer, like an aluminum layer, for example, (as a diffusion barrier), using (the polymer) polyether ether ketone (PEEK) as an internal protective layer. Such a casing can, in embodiments, be implemented as a film bag (pouch cell), as a cylindrical cell or as a prismatic cell (hard casing), for example.

Embodiments provide a casing for holding an ionic liquid comprising aluminum chloride, the casing being a multi-layer casing, the casing comprising a diffusion-tight [like metal] layer, the casing comprising a layer comprising polyether ether ketone, PEEK, wherein, when the casing is filled with the ionic liquid comprising the aluminum chloride, the layer comprising polyether ether ketone, PEEK, is arranged between the diffusion-tight [like metal] layer and the ionic liquid comprising aluminum chloride [for example to protect the diffusion-tight [like metal] layer from the ionic liquid comprising aluminum chloride].

In embodiments, the casing may be a casing for an aluminum graphite dual ion battery cell (AGDIB).

Further embodiments provide a battery cell comprising a multi-layer cell casing, two electrodes [like anode and cathode] and a separator arranged between the two electrodes [for example to electrically insulate the two electrodes from each other], wherein the two electrodes and the separator are arranged in the multi-layer cell casing, wherein the multi-layer cell casing is filled with an electrolyte, wherein a protective layer [like protective film or protective foil] of the multi-layer cell casing, which is in [for example direct] contact with the electrolyte, comprises polyether ether ketone, PEEK.

In embodiments, the protective layer may be a coating or film comprising polyether ether ketone.

For example, the protective layer may be a polyether ether ketone coating or a polyether ether ketone film.

In embodiments, the protective layer may have a thickness of 100 μm [or 50 μm, for example] or less.

In embodiments, the multi-layer casing may comprise a metal layer, wherein the protective layer may be arranged between the electrolyte and the metal layer [for example to protect the metal layer from the electrolyte].

In embodiments, the metal layer may be an aluminum layer.

In embodiments, the multi-layer casing may comprise an electrical insulation layer, wherein the metal layer may be arranged between the protective layer and the electrical insulation layer.

Embodiments may comprise polyamide, PA.

For example, the electrical insulation layer may be a polyamide coating or a polyamide film.

In embodiments, the electrolyte may be an ionic liquid.

In embodiments, the electrolyte may be a strong eutectic solvent [like deep eutectic solvent, DES].

In embodiments, the ionic liquid may be aluminum chloride.

In embodiments, the multi-layer cell casing may be a film bag.

In embodiments, the multi-layer cell casing may be a cylindrical casing.

In embodiments, the multi-layer cell casing may be a prism casing.

In embodiments, the battery cell may be an aluminum ion cell [like aluminum graphite dual ion battery cell (AGDIB)].

In embodiments, a first electrode of the two electrodes may comprise aluminum.

In embodiments, a second electrode of the two electrodes may comprise graphite particles as an active material.

Further embodiments provide a pouch cell comprising a multi-layer film bag, two electrodes [like anode and cathode] and a separator arranged between the two electrodes [for example to electrically insulate the two electrodes from each other], the two electrodes and the separator being arranged in the multi-layer film bag, the multi-layer film bag being filled with an electrolyte, a film layer of the multi-layer film bag, which is in contact with the electrolyte, comprising polyether ether ketone, PEEK.

In embodiments, the film layer, which is in contact with the electrolyte, may be a polyether ether ketone coating or a polyether ether ketone film.

In embodiments, the multi-layer film bag may comprise a metal film layer, wherein the film layer, which is in contact with the electrolyte, may be arranged between the metal film layer and the electrolyte.

In embodiments, the metal film layer may be an aluminum film.

In embodiments, the multi-layer film bag may comprise an electrical insulation layer, wherein the metal film layer may be arranged between the electrical insulation layer and the film layer, which is in contact with the electrolyte.

In embodiments, the electrical insulation layer may be a polyamide coating or a polyamide film.

Further embodiments provide a method of manufacturing a battery cell. The method comprises a step of providing a multi-layer cell casing. Additionally, the method comprises a step of providing two electrodes in the multi-layer cell casing. Furthermore, the method comprises a step of providing a separator between the two electrodes. Additionally, the method comprises a step of filling the casing with an electrolyte, wherein a protective layer [like protective film or protective foil] of the multi-layer cell casing, which is in [direct, for example] contact with the electrolyte, comprises polyether ether ketone, PEEK.

In embodiments, the step of providing the multi-layer cell casing may comprise the following steps: providing a metal layer; and providing the protective layer, wherein the protective layer, after filling the multi-layer cell casing with the electrolyte, is arranged between the metal layer and the electrolyte.

In embodiments, the protective layer may be a polyether ether ketone film.

In embodiments, the protective layer may be provided by coating the metal layer.

In embodiments, the metal layer may be an aluminum film.

In embodiments, the step of providing the multi-layer cell casing may comprise the following step: providing an electrical insulation layer, wherein the metal layer is arranged between the electrical insulation layer and the protective layer.

In embodiments, the electrical insulation layer may be provided by coating the metal layer with polyamide, PA.

Further embodiments provide a method of manufacturing a pouch cell. The method comprises a step of providing a multi-layer film bag. In addition, the method comprises a step of providing two electrodes in the multi-layer film bag. Additionally, the method comprises a step of providing a separator between the two electrodes. Furthermore, the method comprises a step of filling the multi-layer film bag with an electrolyte, wherein a protective layer of the multi-layer film bag, which is in contact with the electrolyte, comprises polyether ether ketone, PEEK.

In embodiments, the step of providing the multi-layer film bag may comprise the following steps: providing a metal film; coating a first side of the metal file with polyether ether ketone to obtain the protective layer; folding the metal film to form a bag such that the protective layer is arranged inside the bag, at least partially sealing the bag.

In embodiments, the step of providing the multi-layer film bag may comprise the following steps: providing a metal film; providing a polyether ether ketone film as a protective layer on a first side of the metal film; folding the metal film and the polyether ether ketone film to form a bag so that the polyether ether ketone film is arranged inside the bag; and at least partially sealing the bag.

In embodiments, the bag may be sealed at least partly by means of welding and/or bonding.

In embodiments, the step of providing the multi-layer film bag may comprise the following step: Coating a second side of the metal film with polyamide, PA.

In embodiments, the bag, after introducing the two electrodes and the separator and filling the bag with the electrolyte, may be sealed in a completely air-tight manner.

### BRIEF DESCRIPTION OF THE DRAWINGS

Embodiments of the present invention will be described in greater detail below referring to the appended drawings, in which:

FIG. 1 is a schematic cross-sectional view of a part of a casing for holding an ionic liquid comprising aluminum chloride in accordance with an embodiment of the present invention;

FIG. 2a is a schematic top view of a battery cell in accordance with an embodiment of the present invention,

FIG. 2b is a schematic cross-sectional view along the sectional axis A-A of the battery cell shown in FIG. 2a in accordance with an embodiment of the present invention,

FIG. 3 is a flow chart of a method of manufacturing a battery cell in accordance with an embodiment of the present invention; and

FIG. 4 is a flow chart of a method of manufacturing a pouch cell in accordance with an embodiment of the present invention.

### DETAILED DESCRIPTION OF THE INVENTION

In the following description of embodiments of the present invention, equal elements or elements of equal effect in the figures will be provided with equal reference numerals so that their description is mutually interchangeable.

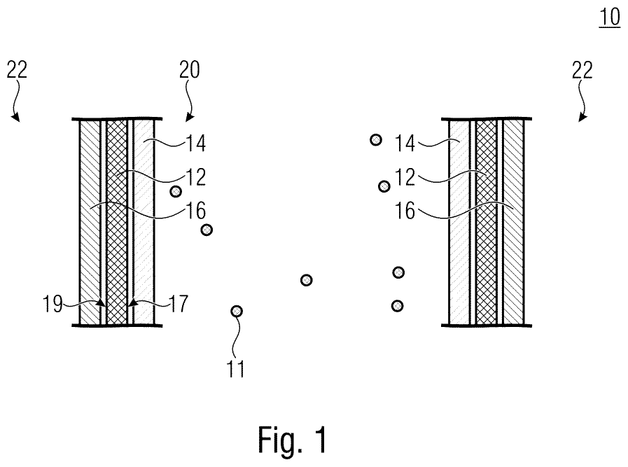

FIG. 1 shows a schematic cross-sectional view of a part of a casing 10 for holding an ionic liquid 11 (like of an electrolyte) comprising aluminum chloride in accordance with an embodiment of the present invention.

As can be gathered from FIG. 1, the casing 10 may be a multi-layer casing which comprises at least one diffusion-tight (like metal) layer 12 and a layer 14 comprising polyether ether ketone (PEEK).

In embodiments, the casing 10 may, for example in a casing interior 20, enclose a volume or form an air-tight chamber, for example for receiving the ionic liquid 11 comprising aluminum chloride.

When the casing 10 is filled with the ionic liquid 11 comprising aluminum chloride (like an electrolyte), the layer 14 comprising PEEK may be arranged between the diffusion-tight layer 12 and the ionic liquid 11 comprising aluminum chloride. In other words, the layer 14 comprising PEEK may be arranged adjacent to a first side (like internal side) 17 of the diffusion-tight/metal layer 12, wherein the first side 17 of the diffusion-tight/metal layer 12 faces the casing interior 20 or the volume enclosed by the casing 10.

In embodiments, the layer 14 comprising PEEK may thus form or be a protective layer configured to protect the diffusion-tight/metal layer 12 from the ionic liquid comprising aluminum chloride.

In embodiments, the layer 14 comprising PEEK may be a coating or film comprising PEEK, like a PEEK coating or a PEEK film, for example.

In embodiments, the layer 14 comprising PEEK may comprise a thickness of 100 μm or less, like 50 μm or less, for example.

In embodiments, the diffusion-tight layer 12 may comprise aluminum. For example, the diffusion-tight layer 12 may be an aluminum layer.

As can be gathered from FIG. 1, the casing 10 in embodiments may additionally comprise an optional electrical insulation layer 16.

In embodiments, the diffusion-tight layer 12 may be arranged between the electrical insulation layer 16 and the layer 14 comprising PEEK. In other words, the electrical insulation layer 16 may be arranged adjacent to a second side (like external side) 19 of the diffusion-tight layer 12, wherein the second side 19 faces away from the casing interior 20 or faces the casing exterior 22.

In embodiments, the electrical insulation layer 16 may comprise polyamide, PA. For example, the electrical insulation layer 16 may be a polyamide coating or a polyamide film.

In embodiments, the casing 10 may be a casing for a battery cell, like an aluminum ion battery cell (AIB), like an aluminum graphite dual ion battery cell (AGDIB).

In embodiments, the casing 10 may be a (multi-layer) film bag (or pouch bag/pouch pocket/multi-layer pouch film), a cylindrical casing or a prism casing.

Embodiments of a battery cell will be described below using the casing 10 shown in FIG. 1.

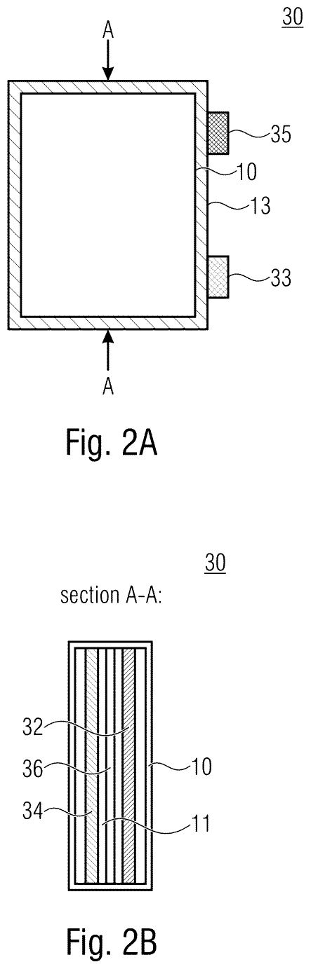

FIG. 2a shows a schematic top view of a battery cell 30 in accordance with an embodiment of the present invention, whereas FIG. 2b shows a schematic cross-sectional view of a sectional axis A-A of the battery cell 30 shown in FIG. 2a.

The battery cell 30 comprises a multi-layer cell casing 10, as described before in detail referring to FIG. 1, two electrodes 32 and 34, like an anode 32 and a cathode 34, for example, and a separator 36 arranged between the two electrodes 32 and 34 (for example to electrically insulate the two electrodes 32 and 34 from each other), wherein the two electrodes 32 and 34 and the separator 36 are arranged in the multi-layer cell casing 10, wherein the multi-layer cell casing 10 is filled with an electrolyte 11, and wherein a protective layer 14 of the multi-layer cell casing 10, which is in (for example direct) contact with the electrolyte 11 (cf. FIG. 1; like protective layer or protective film), comprises PEEK.

In embodiments, a volume enclosed by the cell casing 10 may be filled with the electrolyte 11.

In embodiments, the electrolyte 11 may be an ionic liquid, like a liquid comprising aluminum chloride, for example. In embodiments, the electrolyte 11 may be a strong eutectic solvent.

In embodiments, the first electrode 32 of the two electrodes may comprise aluminum. For example, the first electrode 32 may be an aluminum electrode, like an aluminum anode.

In embodiments, the second electrode 34 of the two electrodes may comprise graphite particles as an active material. For example, the second electrode 34 may be a graphite electrode, like a graphite cathode, for example.

As can be gathered from FIG. 2a, in embodiments, the battery cell 30 may comprise a first contact 33 for the first electrode 32, like a first electrical contact (like tab or connection lug) for connecting/contacting the battery cell, for example, and a second contact 35 for the second electrode 34, like a second electrical contact (like tab or connection lug) for connecting/contacting the battery cell, for example.

In embodiments, the battery cell 30 may be an aluminum ion battery cell (AIB), like an aluminum graphite dual ion battery cell (AGDIB), for example.

In embodiments, the multi-layer cell casing 10 may be a film bag (like a pouch bag), as is exemplarily shown in FIGS. 2a and 2b. Here, the film bag may be sealed at the edges, as is characterized in FIG. 2a by reference numeral 13. Even when, in FIG. 2a, a rectangular film bag is exemplarily shown, it is to be pointed out that the present invention is not restricted to such embodiments, rather, the film bag may comprise any shape, like a polygonal shape, a shape rounded off at the edges, an oval shape or a round shape.

Additionally, it is to be pointed out that the present invention is not restricted to implementing the multi-layer cell casing 10 as a film bag. In embodiments, rather, the multi-layer cell casing 10 may also be a cylindrical cell casing or a prism cell casing.

Further embodiments of the present invention will be described below.

Exemplarily, it is assumed below that the battery cell is a corrosion-resistant aluminum ion battery cell configuration in the form of a pouch cell. However, the following description may also be applied to a different implementation of the battery cell.

In embodiments, an aluminum film of a thickness of 10 to 100 μm, for example, may be used as an anode. In embodiments, for the cathode, graphite particles of a size of 5 to 200 μm, for example, in particular roughly 50 μm, with approximately 2 m % carboxymethyl cellulose (CMC) being added as a binding agent and in an aqueous solution, may be processed to form an aqueous slurry. In embodiments, the deposition on the current drain may be in the form of a molybdenum film, for example by means of manual deposition or by means of film application with subsequent drying. In embodiments, a glass fiber paper or a polyacrylonitrile (PAN) membrane may be used as a separator. In embodiments, ethyl methyl imidazolium chloride:AlCl3 (EMlm[Cl]:AlCl3) or amide:AlCl3 may be used as the electrolyte.

In embodiments, the cell casing may comprise a multi-layer film bag. In embodiments, an aluminum film can be coated with the polymer PEEK corrosion-resistant to the electrolyte on the internal side which is in contact with the electrolyte. In embodiments, the external film side may be coated with PA. In embodiments, the polymer coating may be performed by means of lamination or pasting. In embodiments, the aluminum film protected on both sides can be cut as desired in correspondence with the dimensions of the electrodes and the separator and be welded (one-layer film bag) to form a bag on three sides. Alternatively, in embodiments, a fixed connection between the PEEK film and the Al film on the inside can be dispensed with, wherein a separate PEEK film bag is introduced in an Al film bag, which is coated with PA only on one side, that is on the external side (two-layer film bag). In embodiments, metal strips made of aluminum or molybdenum, so-called tabs, may be welded to the anode and the cathode, which allow contacting of the battery cell outside the film bag. In embodiments, in the area of the welding, the tabs may also be provided with a PEEK coating for air-tight welding of the film bag (one-layer or two-layer implementation). In embodiments, the electrodes with the separator may be introduced in the film bag, in the case of a two-layer implementation, in the internal PEEK film bag. In embodiments, pre-welding of the film bag may take place, in particular of the internal PEEK film bag in the case of a two-layer implementation, in which a small opening for filling the electrolyte and sucking excess gas from inside the film bag remains. In embodiments, after filling the cell with electrolyte, the interior of the pouch bag may be sucked and sealed hermetically/in an air-tight manner.

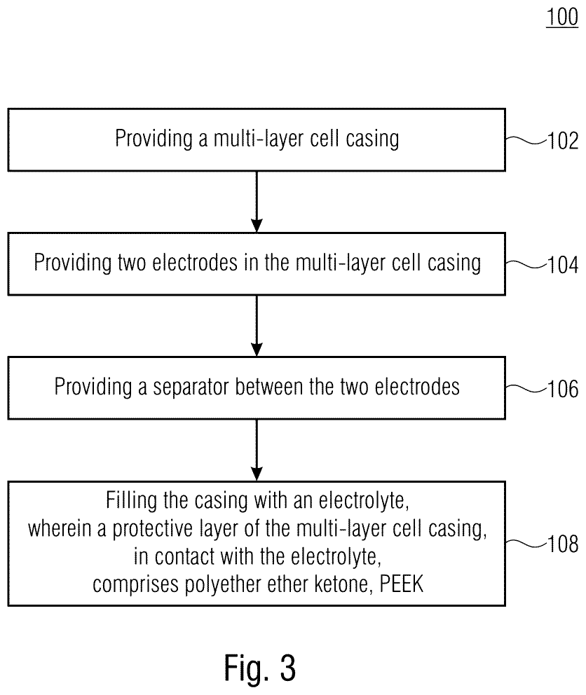

FIG. 3 shows a flow chart of a method 100 for manufacturing a battery cell in accordance with an embodiment of the present invention. The method 100 comprises step 102 of providing a multi-layer cell casing. Additionally, the method 100 comprises step 104 of providing two electrodes in the multi-layer cell casing. Additionally, the method 100 comprises step 106 of providing a separator between the two electrodes. Additionally, the method 100 comprises a step of filling the casing with an electrolyte, wherein a protective layer (like protective film or protective foil) of the multi-layer cell casing, which is in (for example direct) contact with the electrolyte, comprises PEEK.

In embodiments, step 102 of providing the multi-layer cell casing may comprise the following steps: providing a metal layer; and providing the protective layer, wherein the protective layer, after filling the multi-layer cell casing with the electrolyte, is arranged between the metal layer and the electrolyte.

In embodiments, the protective layer may be provided by coating the metal layer. Alternatively, the protective layer may be provided by providing a polyether ether ketone film.

In embodiments, the metal layer may be an aluminum film.

In embodiments, the step of providing the multi-layer cell casing may comprise the following step: providing an electrical insulation layer, wherein the metal layer is arranged between the electrical insulation layer and the protective layer.

In embodiments, the electrical insulation layer may be provided by coating the metal layer with polyamide, PA. Alternatively, the electrical insulation layer may be provided by providing a PEEK film.

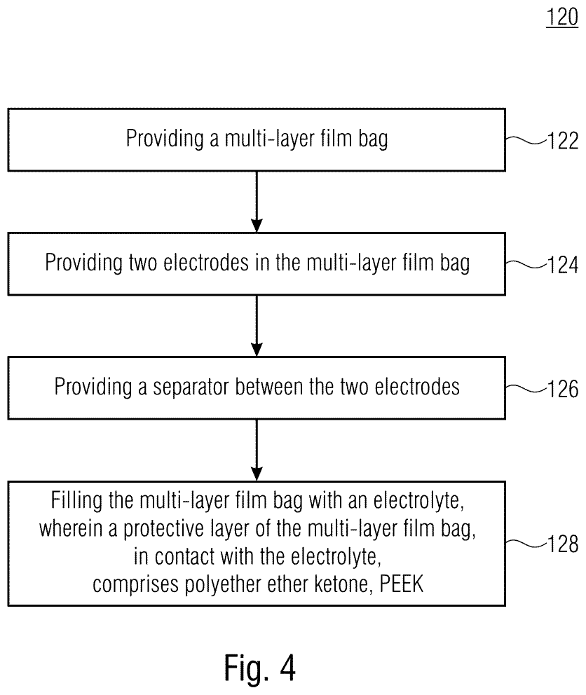

FIG. 4 shows a flow chart of a method 120 for manufacturing a pouch cell in accordance with an embodiment of the present invention. The method 120 comprises step 122 of providing a multi-layer film bag. Additionally, the method 120 comprises step 124 of providing two electrodes in the multi-layer film bag. Additionally, the method 120 comprises a step of providing 126 a separator between the two electrodes. Furthermore, the method 120 comprises step 128 of filling the multi-layer film bag with an electrolyte, wherein a protective layer of the multi-layer film bag, which is in contact with the electrolyte, comprises polyether ether ketone, PEEK.

In embodiments, step 122 of providing the multi-layer film bag may comprise the following steps: providing a metal film; coating a first side of the metal film with polyether ether ketone to obtain the protective layer; folding the metal film to form a bag so that the protective film is arranged inside the bag, at least partly sealing the bag.

In embodiments, step 122 of providing the multi-layer film bag may comprise the following steps: providing a metal film; providing a polyether ether ketone film as a protective layer on a first side of the metal film; folding the metal film and the polyether ether ketone film to form a bag so that the polyether ether ketone film is arranged inside the bag; and at least partly sealing the bag.

In embodiments, the bag may be sealed at least partly by means of welding and/or bonding.

In embodiments, step 122 of providing the multi-layer film bag may comprise the following step: coating a second side of the metal film with polyamide, PA.

In embodiments, the bag, after introducing the two electrodes and the separator and filling the bag with the electrolyte, may be sealed in a completely air-tight manner.

Although some aspects have been described in the context of an apparatus, it is clear that these aspects also represent a description of the corresponding manufacturing method such that a block or device of an apparatus also corresponds to a respective manufacturing method step or a feature of a manufacturing method step. Analogously, aspects described in the context of or as a manufacturing method step also represent a description of a corresponding block or item or feature of a corresponding apparatus. Some or all of the method steps may be executed by (or using) a hardware apparatus, like, for example, a microprocessor, a programmable computer or an electronic circuit. In some embodiments, some or several of the most important method steps may be executed by such an apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] G. A. Elia, K. V. Kravchyk, M. V. Kovalenko, J. Chacóne, A. Holland, R. G. A. Wills. J. Power Sources. 2021, vol. 481, p. 228870
[2] S. Wang, K. V. Kravchyk, A. N. Filippin, U. Müller, A. N. Tiwari, S. Buechler, M. I. Bodnarchuk, M. V. Kovalenko. Adv. Sci. 2018, vol. 5, p. 1700712
[3] US 2020/0036033 A1

1. A battery cell comprising:
a two-layer film bag,
two electrodes, and
a separator arranged between the two electrodes,
wherein the two electrodes and the separator are arranged in the two-layer film bag,
wherein the two-layer film bag is filled with an electrolyte,
wherein a protective layer of the two-layer film bag, which is in contact with the electrolyte, comprises polyether ether ketone, PEEK,
wherein the protective layer is a polyether ether ketone, PEEK, film bag,
wherein the two-layer film bag comprises an aluminum film bag coated with polyamide on an external side,
wherein the polyether ether ketone, PEEK, film bag is introduced into the aluminum film bag.

2. The battery cell in accordance with claim 1,
wherein the two-layer film bag, on the inside, does not comprise a fixed connection between the polyether ether ketone, PEEK, film bag and the aluminum film bag,
wherein the protective layer is a coating or film comprising polyether ether ketone.

3. The battery cell in accordance with claim 1,
wherein the protective layer comprises a thickness of 100 μm or less.

4. The battery cell in accordance with claim 1,
wherein the electrolyte is an ionic liquid,
or wherein the electrolyte is a strong eutectic solvent.

5. The battery cell in accordance with claim 4,
wherein the ionic liquid comprises aluminum chloride.

6. The battery cell in accordance with claim 1,
wherein the two-layer film bag is a cylindrical casing.

7. The battery cell in accordance with claim 1,
wherein the two-layer film bag is a prism casing.

8. The battery cell in accordance with claim 1,
wherein the battery cell is an aluminum ion cell.

9. The battery cell in accordance with claim 1,
wherein a first electrode of the two electrodes comprises aluminum,
and/or wherein a second electrode of the two electrodes comprises graphite particles as an active material.

10. A pouch cell comprising:
a two-layer film bag,
two electrodes, and
a separator arranged between the two electrodes,
wherein the two electrodes and the separator are arranged in the two-layer film bag,
wherein the two-layer film bag is filled with an electrolyte,
wherein a film layer of the two-layer film bag, which is in contact with the electrolyte, comprises polyether ether ketone, PEEK,
wherein the film layer which is in contact with the electrolyte is a polyether ether ketone, PEEK, film bag,
wherein the two-layer film bag comprises an aluminum film bag coated with polyamide on an external side,
wherein the polyether ether ketone, PEEK, film bag is introduced into the aluminum film bag.

11. A method of manufacturing a battery cell, the method comprising:
providing a two-layer film bag,
providing two electrodes in the multi-layer cell casing,
providing a separator between the two electrodes,
filling the cell casing with an electrolyte,
wherein a protective layer of the multi-layer cell casing, which is in contact with the electrolyte, comprises polyether ether ketone, PEEK,
wherein providing the two-layer film bag comprises:
providing a polyether ether ketone, PEEK, film bag as a protective layer,
providing an aluminum film bag which is coated with polyamide on an external side,
introducing the polyether ether ketone, PEEK, film bag into the aluminum film bag.

12. A method of manufacturing a pouch cell, the method comprising:
providing a two-layer film bag,
providing two electrodes in the two-layer film bag,
providing a separator between the two electrodes,
filling the two-layer film bag with an electrolyte,
wherein a protective layer of the two-layer film bag, which is in contact with the electrolyte, comprises polyether ether ketone, PEEK,
wherein providing the two-layer film bag comprises:
providing a polyether ether ketone, PEEK, film bag as a protective layer,
providing an aluminum film bag which is coated with polyamide on an external side,
introducing the polyether ether ketone, PEEK, film bag into the aluminum film bag.
